(19) United States
(12) Patent Application Publication
(10) Pub. No.: US 2007/0162217 A1
(43) Pub. Date: Jul. 12, 2007

(54) Counter-rotating regenerative flywheels for damping undesired oscillating motion of watercraft

(76) Inventor: Gregory Allen Selbe, Honolulu, HI (US)

Correspondence Address: CADES SCHUTTE A LIMITED LIABILITY LAW PARTNERSHIP, 1000 BISHOP STREET, 12TH FLOOR, HONOLULU, HI, 96813, US

(21) Appl. No.: 11/639,471

(22) Filed: Dec. 14, 2006

Related U.S. Application Data
(60) Provisional application No. 60/750,703, filed on Dec. 14, 2005.
(60) Provisional application No. 60/773,416, filed on Feb. 13, 2006.

(51) Int. Cl. G05D 1/00

(52) U.S. Cl. 701/116; 701/21

(57) ABSTRACT

Pairs of counter-rotating regenerative flywheels (20, 30 and 60, 70) create reinforcing torques when electrical energy is transferred between the members of a pair. The transfer of electricity can be controlled to counter undesired oscillations of a watercraft (10). Motion of the watercraft (10) is sensed by a sensor system (110), resolved into components and then the flywheels are controlled to apply torque that counteracts the undesired oscillation. Preferably, the motion of the watercraft is evaluated by the sensor in brief increments of one-tenth of a second or less.

This application claims priority to U.S. provisional patent application 60/750,703 filed Dec. 14, 2005, incorporated herein by reference, and to U.S. provisional patent application 60/773,416, filed Feb. 13, 2006, incorporated herein by reference.

### TECHNICAL FIELD

Oscillating motion is the up and down, or back and forth, motion of an object connected to, or sitting on, a springy material, substance or object. Watercraft, such as yachts, personal and commercial fishing boats, personal recreational boats, ships, etc., experience undesired oscillating motions, such as pitch (front and rear going up and down) and roll (right and left going up and down) caused by surface waves or other forces. These undesired oscillating motions, also called oscillations, may cause seasickness, cargo shifting or other motion related problems. “Damping” (explained below) of oscillations may avoid or reduce these problems.

### BACKGROUND ART

Oscillations can be reduced by friction or other means, so that the oscillations become smaller over time. Reduction of oscillations is called “damping.” An example of damping of oscillations is shock absorbers in cars: shock absorbers reduce the oscillations a car would experience if it had a suspension system with springs only; when driving over a bump, a car with broken shock absorbers bounces up and down many times, but a car with functioning shock absorbers bounces only once, or a few times.

In order to dampen oscillations of a watercraft, twisting forces can be applied to the hull of the watercraft that are timed in such a way that the twisting forces oppose the direction of the rolling or pitching motions, therefore partially or completely damping the oscillations. Because these twisting forces oppose the oscillation of the rolling or pitching motions, these twisting forces also oscillate.

Flywheels store energy of spinning, that is, rotational kinetic energy. Changing the rotational kinetic energy of a spinning flywheel is caused by applying torque, that is, a twisting force. Applying torque in the direction of rotation increases the rotation rate, and applying torque opposite the direction of rotation decreases the rotation rate. According to Newton's third law, for every action, there is an equal and opposite reaction. Thus, if a twisting force from the shaft or housing of a flywheel causes the rotational rate of the flywheel to speed up, then the twisting force also applies an equal and opposite twisting force to the shaft or housing of the flywheel.

U.S. Pat. No. 6,234,427 to Decker discloses a satellite power regulation and pointing system that comprises a power bus and first and second flywheels capable of storing rotational energy, wherein each flywheel comprises a flywheel motor/generator for increasing the rotational energy in its associated flywheel when storing power in its associated flywheel and for reducing the associated flywheel rotational energy when drawing power from its associated flywheel.

U.S. Pat. No. 5,660,356 to Selfors, et al., discloses a dual flywheel assembly for use in an airborne vehicle for storing mechanical energy therein, which includes two flywheels which are linked by a suitable linkage structure such that, if rolled motion of the vehicle starts to occur during flight, the flywheel tilts in equal and opposite directions out of their normal planes of rotation, which tilting motions act in a passive manner to stabilize the rolled motion of the vehicle.

U.S. Pat. No. 4,723,735 to Eisenhaure, et al., discloses an energy storage attitude control and reference system for a craft, including at least two flywheels with their angular momenta balanced to produce zero net angular momentum and at least two motor/generator units, each including one of the flywheels in its rotor structure.

An article entitled “Mechanism of Attitude Control Device for Floating Object” by Toshiaki Tsuji and Kouhei Ohnishi, published in Proc IEEE Int Conf Ind Technol, pp. 250-255 (2003) discloses two coaxial counter-rotating flywheels, each of which is provided with a brake to increase torque and decrease response time for attitude control.

An article entitled “Sensorless Oscillation Control of a Suspended Load with Flywheels” by Koichi Nishimura, Toshiaki Tsuji and Kouhei Ohnishi published in 2006 in IEEJ Trans. Ind Appl, vol. 126, No. 8, pp. 1119-1125, discloses applying reaction torque of flywheels for oscillation control, but this article was published after at least the earliest provisional application described above. Reference 6 at the end of this article lists the immediately preceding article as “A Mechanism on Attitude Control Device for Flying Object”, not “Floating Object.”

An article entitled “Oscillation Control of Suspended Load with Flywheels” by T. Tsjui and K. Ohnishi published in Transactions of the Institute of Electrical Engineers of Japan, Part D, vol. 125-D, no. 6, pp. 548-53, discloses applying reaction torque of a flywheel for oscillation suppression of a suspended load using a sensorless estimation method having a bandpass filter. Applicant may have conceived of his invention before this article was published.

An article entitled “A Combined Energy and Attitude Control System for Small Satellites” published in ACTA Astronautica (ISSN 0094-5765), Volume 54, No. 10, May 1994, pages 701-712), discloses a double counter-rotating flywheel assembly serving simultaneously for satellite energy storage and attitude control tasks.

An article entitled “Hybrid Battery and Flywheel Energy Storage System for Leo Spacecraft” by B. Beaman, et al., discloses two counter-rotating wheels used to produce a flywheel energy storage system that can replace one of the attitude control wheels in the attitude control system wheel set.

Mitsubishi Heavy Industries and The Ferretti Group have developed an anti rolling gyro to reduce the rolling motion of yachts, as disclosed in “Popular Science”, December 2005, page 76, and the “special projects” section of www.ferrettigroup.com.

### DISCLOSURE OF INVENTION

If a single flywheel is mounted in or on the hull of a watercraft, then speeding up and slowing down the flywheel will apply twisting forces to the shaft and/or the housing of the flywheel, and the shaft and/or the housing will apply twisting forces to the watercraft itself. For example, if the spinning flywheel is braked suddenly to a stop using brakes on the shaft or the housing, the brakes would apply a twisting force to the watercraft in the same direction as the flywheel was spinning.

Thus, it is theoretically possible to apply desired twisting forces to a watercraft by speeding up and slowing down a flywheel. The flywheel would need to have substantial mass or substantial rotational speed to generate enough twisting force to affect the watercraft. The flywheel could be provided with an electric motor to speed it up, and a brake to slow it down. However, it would require very substantial amounts of electricity to apply substantial twisting force to a flywheel with substantial mass or with substantial rotational speed.

It is not necessary to position the flywheel on the axis of the craft—the flywheel can be displaced from the axis and still provide torque as it speeds up or slows down.

Certain types of electric motors act as a motor when turning the shaft of a flywheel, or as a generator if the shaft is rotated by the flywheel. They are referred to as motor-generators, or motors, or generators.

Thus, instead of using a brake to slow down the flywheel, a rechargeable battery can be used, so that speeding up the flywheel drains the battery and slowing down the flywheel charges the battery. This is the principle of regenerative braking used in hybrid cars. Thus, a flywheel attached to an electric motor (which can also act as a generator) that can charge a battery is a regenerative flywheel. A transmission system of gears, chains or belts may optionally be provided to function between the motor-generators and the flywheels in order that the motor-generators may rotate at their most efficient speeds when accelerating the flywheels as motors or decelerating the flywheels as generators.

However, batteries are heavy and inefficient, and the amounts of energy necessary to create substantial torque are very high, so the batteries would need to have very substantial storage capacity.

Instead of a battery, a second regenerative flywheel could be used. That second regenerative flywheel could then give and receive electrical energy from the first regenerative flywheel, just like a rechargeable battery. Slowing down the first flywheel by generating electricity would speed up the second flywheel by applying that generated electricity to the motor for the second flywheel, and vice versa.

Further, if the second regenerative flywheel is placed so that its axis of rotation is parallel to the axis of rotation of the first regenerative flywheel, and the second flywheel rotates in the opposite direction from the first flywheel, then the torque applied to the watercraft by speeding up and slowing down of the second flywheel will be in the same direction as the torque applied to the watercraft by slowing down and speeding up of the first flywheel. Thus, both flywheels will generate torques applied to the watercraft in the same direction, which will reinforce each other.

Accordingly, a pair of counter-rotating electrically connected regenerative flywheels having parallel axes of rotation can generate reinforcing torques.

Two counter rotating, electrically connected, regenerative flywheels (also called “flywheels” or “flywheel”) can therefore be mounted in or on the hull of a watercraft with their axes of rotation parallel to each other. If one of the flywheels is made to act as a generator and the electricity generated is sent to the motor of the other, the generator flywheel will slow down and the motor flywheel will speed up. Both flywheels will apply torque in the same direction to the craft.

For example, looking from the back to the front, if the flywheels are mounted with their axes of rotation parallel to the craft's longitudinal axis, one on the left and one on the right, if the left flywheel is rotating counterclockwise, and the right flywheel is rotating clockwise, slowing down the left flywheel to generate electricity in order to speed up the right flywheel will create torque in both flywheels in the same counterclockwise direction. The torque will then apply counterclockwise force to twist the watercraft. Because electricity can be quickly and easily transferred back and forth between the flywheels, the torque generated by the flywheels can be easily reversed in direction, so that the torque can be made to oscillate, to create an oscillating torque. Because the torque changes over time, that is, it is not static, then the torque is dynamic. Thus the flywheels can apply dynamic damping torque.

Every craft tends to have a natural frequency, that is, it tends to roll or pitch at a specific frequency when a force is applied, as from a surface wave. The paired regenerative flywheels can be controlled so that they generate oscillating torques at or near this natural frequency, and in directions opposite to the oscillations of the watercraft. If the oscillating torques are strong enough, they can completely cancel out the natural frequency oscillations of the watercraft.

Control of the flywheels can be accomplished by providing sensors to detect the oscillating motion of the craft, and a computer (including a computer chip, programmable logic controller or other controlling device) can be provided that controls the flywheel, through a “regulator”. A regulator (including a motor-generator controller), energizes certain control windings in the motor-generators in order to cause the motor-generators to operate as motors or as generators and also to control the speed of the motors and the amount of energy generated by the generators. The regulator can be used to control the flywheels so as to apply oscillating torque that completely or partially cancels or dampens the detected oscillating motion. Indeed, with appropriate sensors and control of the current between the regenerative flywheels, additional torque can be applied as necessary to cancel or dampen any additional motions that may be detected, so as to provide dynamic damping torque to damp the additional motions.

Of course, paired regenerative flywheels can also be placed on the craft with their axes of rotation transverse to the longitudinal axis of the craft, to generate oscillating torques twisting the craft from front to back, to dampen oscillating pitch motion. However, it is presently preferred to provide only paired regenerative flywheels to dynamically damp oscillating roll motion.

It must be noted that this invention differs from a gyroscope. A gyroscope will react to an applied torque with a reaction torque that is 90 degrees away from the applied torque (called “precession”). By contrast, the counter rotating regenerative flywheels described herein react to an applied torque with a reaction torque that is directly opposite the applied torque. Also, this invention uses counter-rotating pairs of flywheels, so that any precession from one flywheel is canceled by the precession from the other.

Because it may be necessary to transfer such substantial amounts of electrical current between the regenerative flywheels of each pair, it is preferred to electrically connect them with bus bars or other high current connections.

It is also preferred to use flywheels with high rotational velocities to reduce the amount of mass of the flywheels.

### BRIEF DESCRIPTION OF DRAWINGS

FIG. 1 is a rear elevational view of a watercraft conceptually showing a pair of counter-rotating regenerative flywheels to apply torque for damping roll;

FIG. 2 is a rear elevational view of the watercraft of FIG. 1 conceptually showing the counter-rotating regenerative flywheels applying torque to damp a roll to starboard;

FIG. 3 is a rear elevational view of the watercraft of FIG. I conceptually showing the counter-rotating regenerative flywheels applying torque to damp a roll to port;

FIG. 4 is a top plan view of a watercraft with two sets of counter-rotating regenerative flywheels, not necessarily to scale, one for damping roll and one for damping pitch, controlled by a sensor a computer, and a regulator;

FIG. 5 is a top plan view of a watercraft with two sets of counter-rotating regenerative flywheels, one for damping roll and one for damping pitch, not necessarily to scale, controlled by a sensor a computer, and a regulator, where the flywheels in each pair are coaxial.

### BEST MODE FOR CARRYING OUT THE INVENTION

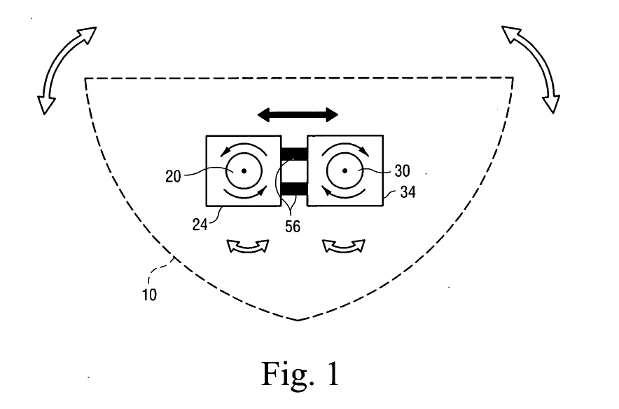

The presently preferred best mode for carrying out the present invention are illustrated by way of example in FIGS. 1-5.

Referring to FIG. 1, shown is an elevational view from the rear of a watercraft 10 with a first regenerative flywheel 20 mounted in a first housing 24 and a second regenerative flywheel 30 mounted in a second housing 34. The first regenerative flywheel 20 and second regenerative flywheel 30 are electrically connected, preferably by bus bars 56. The first regenerative flywheel 20 rotates in a first direction and the second regenerative flywheel 30 rotates in the opposite direction to form a pair of counter-rotating regenerative flywheels (as indicated by the rotational velocity arrows next to the flywheels). As indicated by the larger hollow arrows, the watercraft 10 may rotate around its longitudinal (roll) axis in a rotational motion referred to as roll or rolling. As indicated by the smaller hollow arrows, the first flywheel 20 and the second flywheel 30 can apply torque to counteract the roll if the flywheels are accelerated or decelerated. As indicated by the solid arrow, electrical energy can be transferred from the first flywheel 20 to the second flywheel 30, or vice versa, over the bus bars 56, to accelerate or decelerate either flywheel.

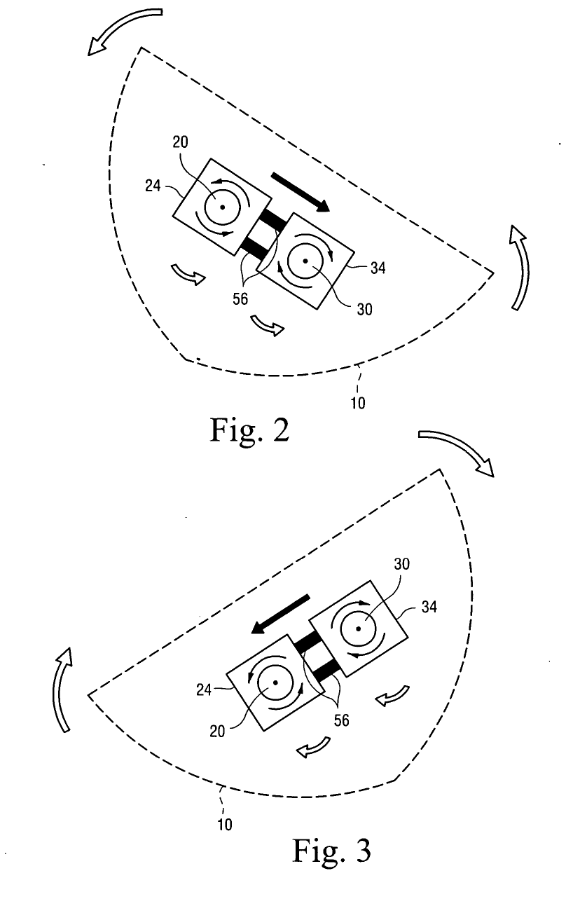

Referring to FIG. 2, shown is the watercraft 10 of FIG. 1 undergoing a rolling motion to starboard (right), so that the starboard side is lower than the port (left) side. In order to counteract this roll, it is necessary to apply torque counterclockwise as indicated by the large hollow arrows. In order to apply this counterclockwise torque, electricity is transferred from the first regenerative flywheel 20 to the second regenerative flywheel 30 over the bus bars 56, as shown by the solid arrow. Drawing electricity from the first regenerative flywheel 20 slows down the rotation of the first regenerative flywheel 20 and accelerates the rotation of the second regenerative flywheel 30 (as indicated by the rotational velocity arrows next to the flywheels). Drawing electricity from the first regenerative flywheel 20 is accomplished by causing it to act as a generator, which causes the housing 24 to apply a force to slow down that flywheel 20. This generation of electricity causes an equal and opposite force to be applied to the first flywheel housing 24, thus resulting in a counterclockwise torque. Simultaneously, the second regenerative flywheel 30 is sped up by the electrical energy from the first flywheel as indicated by the solid arrow, and this acceleration of the second regenerative flywheel creates an equal and opposite force on the second flywheel housing 34, again resulting in a counterclockwise torque. Thus, as can be seen, transferring electrical energy from the first regenerative flywheel 20 to the second flywheel 30 results in torque being applied to the first flywheel housing 24 and second flywheel housing 34 in the same direction. Accordingly, transferring electrical power from first flywheel 20 to second flywheel 30 results in reinforcing torques.

Referring to FIG. 3, shown is the watercraft of FIG. 1 with first regenerative flywheel 20 in first flywheel housing 24 and second regenerative flywheel 30 in flywheel housing 34 with the watercraft shown rolling to port, so that the port side is lower than the starboard side. In order to dampen this oscillation, a torque must be applied in the clockwise direction, as shown by the large hollow arrows. In this circumstance, second regenerative flywheel 30 is made to act as a generator to provide electricity that is transferred over the bus bars 56 to first regenerative flywheel 20, which causes deceleration of second regenerative flywheel 30, to create a clockwise torque on the second flywheel housing 34, and acceleration of first regenerative flywheel 20, to create a clockwise torque on the first flywheel housing 24 (as indicated by the rotational velocity arrows next to the flywheels). Thus, the transfer of electrical energy from second regenerative flywheel 30 to first regenerative flywheel 20 results in a torque in the clockwise direction as indicated by the smaller hollow arrows.

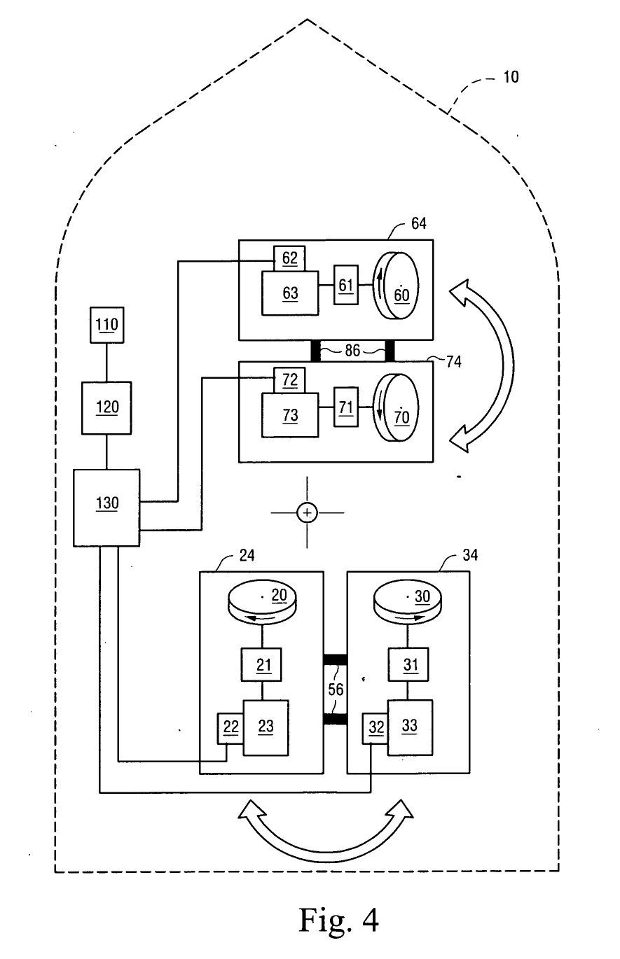

Referring to FIG. 4, shown is a top plan view of the watercraft 10 with a first roll flywheel 20, a first roll transmission system 21, a first roll motor-generator 23 and first roll control windings 22 housed in first roll flywheel housing 24, and a second roll flywheel 30, a second roll transmission system 31, a second roll motor-generator 33 and second roll control windings 32 housed in second roll flywheel housing 34, with axes parallel to the longitudinal (or roll) axis of the watercraft and electrically connected by roll bus bars 56, together with a first pitch flywheel 60, a first pitch transmission system 61, a first pitch motor-generator 63 and first pitch control windings 62, housed in first pitch flywheel housing 64, and a second pitch flywheel 70, a second pitch transmission system 71, a second pitch motor-generator 73 and second pitch control windings 72, housed in second pitch flywheel housing 74, with axes parallel to the latitudinal (or pitch) axis of the watercraft and electrically connected by pitch bus bars 86. Similar to the first roll flywheel 20 and the second roll flywheel 30, the first pitch flywheel 60 and second pitch flywheel 70 can provide reinforcing torque to counter oscillation of the watercraft 10, but this time along the latitudinal (or pitch) axis of the watercraft.

A sensor 110, preferably a gyroscopic sensor, is provided that can sense motion of the watercraft 10. Preferably, the sensor 110 senses motion of the watercraft 10 at intervals of 1/10 second or less. Information from the sensor 110 is provided to a computer 120 and resolved into roll and pitch components, so that the boat's oscillation on the roll and pitch axes can be determined. The computer 120 is controllably connected to the regulator 130 so as to regulate the control windings 22, 32, 62 and 72 in order to control the flow of electrical energy between the first roll flywheel and second roll flywheel and between the first pitch flywheel and the second pitch flywheel. If desired, a third pair of flywheels (not shown) can similarly be provided to provide torque along the yaw (right to left) axis.

It would be well within the skill of a person of ordinary skill in the art to select the specific masses and configurations of the flywheels and the motor generators. Indeed, the flywheels can be integrally formed with the motor generators for simplicity and economy of construction and to eliminate transmissions. Motor generators basically comprise a stator or housing that does not rotate, a rotor or armature, which rotates within the stator, and electrical wires wound around the stator and the armature (called “windings”) and connected so that electrical current flowing through the windings creates interacting magnetic fields in the stator and the armature that cause the armature to rotate. Thus, if the rotating armatures of the motor generators have sufficient radially outwardly positioned mass, the armatures themselves could function as flywheels and provide damping torque. For example, the windings are conventionally made of copper, and the armature conventionally is made of iron and includes spokes or other members that extend radially outward, with the windings wound around the spokes or other members. The spokes or other members therefore form a core around which the windings are wound. The spokes or other members can be configured so that their mass is concentrated radially outwardly, if desired, or additional mass can be attached to radially outward portions of the armature's spokes.

The integrally formed motor generator and flywheel can be analyzed as providing angular momentum substantially equivalent to a rotating ring shaped mass. Using this analysis, accelerating the rotating armature (of a motor generator) providing angular momentum that is substantially equivalent to a ring shaped mass (having an outer diameter of 48 centimeters, an inner diameter of 41 centimeters, a width of 7 centimeters and a mass of 23 kilograms) from 120 revolutions per minute to 2250 revolutions per minute in 2.5 seconds would produce angular momentum of approximately 250 Newton meter seconds and require approximately 25,000 watts of power (17 horsepower). When combined with a control system having a sensor to detect roll or pitch motion of a watercraft (and to actuate such armatures to provide angular momentum to damp such motion), two such counter rotating armatures on the same shaft (with separate bearings to allow the armatures to spin in opposite directions), within one stator housing, with electrical connections allowing electricity to accelerate one rotating armature to be drawn from the other (decelerating) armature acting as a generator, the combined angular momentum from the armatures can damp the roll or pitch motion of a watercraft, with a combined angular momentum from the armatures equal to approximately 500 Newton meter seconds, enough to provide stabilization for a watercraft having up to approximately 4500 kilograms (10,000 lbs) of mass. A similar analysis with an armature providing angular momentum substantially equivalent to a ring shaped mass (having an outer diameter of 62 centimeters, an inner diameter of 56 centimeters, a width of 11 centimeters and a mass of 39 kilograms), accelerating from 300 RPM to 1750 RPM in 3.5 seconds would require 31,500 watts of power (21 horsepower) and would produce approximately 1000 Newton meter seconds, enough to provide damping torque for water craft having up to approximately 9100 kilograms (20,000 lbs). Larger diameter, differently shaped and more massive rotating armatures could be configured as a simple matter of design choice to produce greater or lesser amounts of angular momentum to stabilize larger watercraft or smaller watercraft.

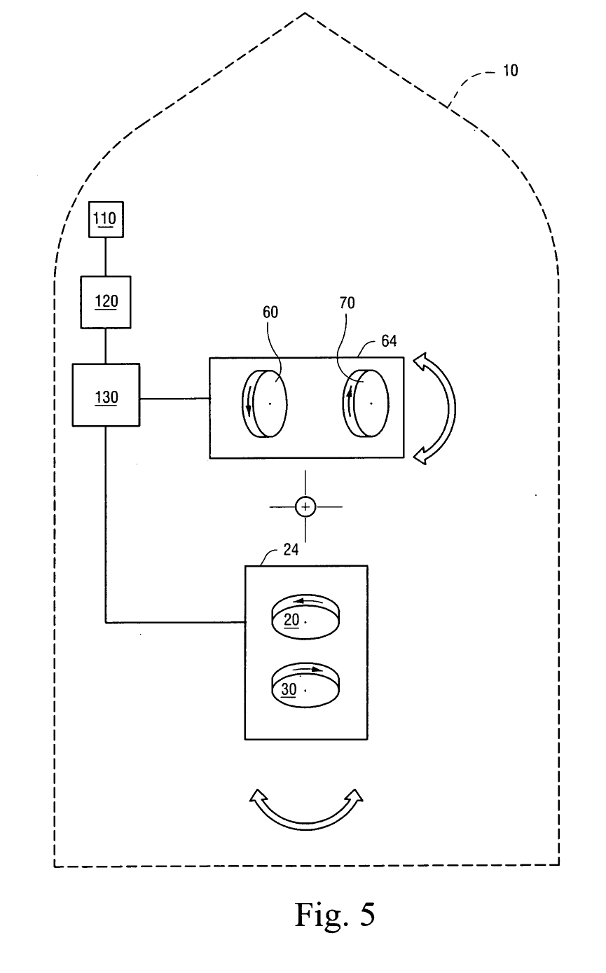

Referring to FIG. 5, shown is a watercraft 10 with first roll integrally formed motor generator and flywheel 20 and second roll integrally formed motor generator and flywheel 30, but mounted coaxially and housed in a single roll flywheel housing 24. Optionally, first pitch integrally formed motor generator and flywheel 60 and second pitch integrally formed motor generator and flywheel 70 are coaxially mounted in a single pitch flywheel housing 64. Again, a sensor system 110 and a computer 120, which is controllably connected to the regulator 130 are provided in order to control the flow of electrical energy between the first roll flywheel 20 and second roll flywheel 30 and the optional first pitch flywheel 60 and optional second pitch flywheel 70 along bus bars connecting them.

The present invention has been disclosed in connection with the presently preferred best modes described herein, but it will be obvious to those skilled in the art that various changes may be made in the disclosed preferred embodiments without departing from the spirit and scope of the invention. Accordingly, no limitations are to be implied or inferred in this invention except as specifically set forth in the attached claims.

### INDUSTRIAL APPLICABILITY

This invention can be used whenever it is desired to provide a force to counteract or damp undesired oscillation and other motion.

What is claimed is:

1. A device for damping oscillations of a watercraft having a roll axis and a pitch axis, comprising:
a pair of counter-rotating electrically connected regenerative flywheels having parallel axes of rotation mounted on said watercraft;
a regulator controllably connected to said flywheels;
a sensor to sense oscillations of said watercraft; and
a computer connected to said sensor and said regulator to control said flywheels through said regulator to apply dynamic damping torque to dynamically damp said oscillations of said watercraft.

2. A device according to claim 1, wherein said axes of rotation of said flywheels are parallel to said roll axis of said watercraft, whereby said flywheels apply dynamic damping torque to dampen roll oscillations of said watercraft.

3. A device according to claim 1, wherein said axes of rotation of said flywheels are parallel to said pitch axis of said watercraft, whereby said flywheels apply dynamic damping torque to dampen pitch oscillations of said watercraft.

4. A device according to claim 1 or claim 2, wherein said flywheels are coaxial.

5. A watercraft, comprising:
a hull having a roll axis;
a first regenerative flywheel having a first axis of rotation mounted on said hull with said first axis of rotation parallel to said roll axis;
a second regenerative flywheel having a second axis of rotation mounted on said hull with said second axis of rotation parallel to said roll axis and electrically connected to said first regenerative flywheel;
a regulator controllably connected to both of said flywheels;
a sensor for sensing oscillations of said watercraft around said roll axis; and
a computer connected to said sensor and said regulator to control said flywheels through said regulator to apply dynamic damping torque to dynamically damp said oscillations of said watercraft.

6. A watercraft according to claim 5, wherein said first axis of rotation and said second axis of rotation are the same, whereby said first flywheel and said second flywheel are coaxial.

7. A process for creating torque to damp undesired oscillations of a watercraft, comprising:
mounting first and second counter rotating electrically connected regenerative flywheels on said watercraft;
controlling said flywheels to cause one of said flywheels to generate electricity and decelerate and to apply said electricity to the other of said flywheels to accelerate, and vice versa, and to cause said deceleration and said acceleration to oscillate and damp said oscillations;
whereby said oscillating accelerations and decelerations of said flywheels create reinforcing torques that damp said oscillations.

8. A process for using pairs of counter-rotating electrically connected regenerative flywheels having parallel axes of rotation, comprising:
mounting said flywheels on a watercraft to apply dynamic damping torque to damp oscillations of said watercraft.

9. A device for damping oscillations of a floating watercraft having a roll axis and a pitch axis, comprising:
a pair of coaxially mounted counterrotating armatures housed in a single stator, wherein said armatures are provided with sufficient radially outwardly positioned mass to function as flywheels to provide damping torque;
electrical connections between said armatures and said stator allowing electricity generated by a decelerating armature, acting as a generator, to accelerate the other counter rotating armature, acting as a motor; and
a control system having a sensor to detect roll or pitch motion of a watercraft and to actuate such armatures to provide angular momentum to damp such motion.

10. A device according to claim 9, wherein each of said armatures provides angular momentum substantially equivalent to a ring shaped mass having an outer diameter of between approximately 48 and approximately 62 centimeters, an inner diameter of between approximately 41 and approximately 56 centimeters, a width of between approximately 7 centimeters and approximately 11 centimeters, and a mass of between approximately 23 kilograms and approximately 39 kilograms.
